(19) United States
(12) Patent Application Publication
(10) Pub. No.: US 2010/0194017 A1
(43) Pub. Date: Aug. 5, 2010

(54) IMAGE FORMING APPARATUS AND IMAGE FORMING METHOD FOR IMAGE FORMING APPARATUS

(75) Inventor: Kiyokazu ONO, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/699,492

(22) Filed: Feb. 3, 2010

Related U.S. Application Data
(60) Provisional application No. 61/150,253, filed on Feb. 5, 2009.

(51) Int. Cl. B41F 13/54

(52) U.S. Cl. 270/1.01

(57) ABSTRACT

An image forming apparatus includes a dog-earing arm which folds a corner of a recording medium, and a dog-eared fold reinforcing portion which presses the corner of the recording medium folded by the dog-earing arm and thus reinforces the fold. The image forming apparatus prints an ID at a position that can be visually recognized when the recording medium is folded in the middle, and then fold the recording medium in the middle. Therefore, a print user can be specified without viewing the inside of a printed matter that is folded in the middle. There is an advantage that security can be secured simply without raising the print cost.

### CROSS-REFERENCE TO RELATED APPLICATIONS

This application is based upon and claims the benefit of priority from the prior U.S.A. Patent Application No. 61/150,253, filed on 5 Feb., 2009, the entire contents of which are incorporated herein by reference.

### TECHNICAL FIELD

The present invention relates to an image forming apparatus such as a copy machine and particularly to an image forming apparatus that can improve security simply.

### BACKGROUND

An image forming apparatus such as a copy machine is often used by plural users. However, in some cases, a user does not want other people to view the user's own printed contents. That is, there is a demand that simple security should be secured to prevent printed contents from being viewed by other people.

To cope with this demand, for example, JP-A-2001-322337 discloses a technique in which plural trays are provided in a finisher and a print user is enabled to confirm which tray a printed recording medium is discharged to, and the finisher sorts and discharges papers to corresponding trays.

However, this technique has a problem that since trays of the same number as the number of print users are needed, the number of print users who can share the image forming apparatus is limited.

Meanwhile, for example, JP-A-2004-284750 discloses a technique of covered binding so that a printed content comes inside.

However, this technique has a problem that who the print user is cannot be easily confirmed.

### SUMMARY

It is an object of the present invention to provide an image forming apparatus and an image forming method for an image forming apparatus that can enhance security simply.

In an aspect of the present invention, an image forming apparatus includes:

an image forming unit which forms an image on a recording medium;

a first folding unit which folds the recording medium having the image formed thereon, in the middle;

a second folding unit which folds a corner of the recording medium that is carried downstream from the first folding unit in a recording medium carrying direction; and

a control unit which forms an image of ID at a position corresponding to the folded corner of the recording medium, using a straight line to be a fold of middle folding on a print side of the recording medium, as a symmetry axis.

### DESCRIPTION OF THE DRAWINGS

FIG. 1 is a side sectional view showing an image forming apparatus.

FIG. 2 is a block diagram showing a control system of the image forming apparatus and a finisher.

FIG. 3 is a perspective view showing the appearance of a second folding unit.

FIG. 4A shows the operation of a dog-earing arm.

FIG. 4B shows the sequel to the operation of the dog-earing arm 63D.

FIG. 5 shows the state of a recording medium before middle folding.

FIG. 6 shows the state of the recording medium that is folded in the middle and discharged on a stack tray.

### DETAILED DESCRIPTION

Throughout this description, the embodiments and examples shown should be considered as exemplars, rather than limitations on the apparatus and methods of the present invention.

Hereinafter, an embodiment of an image forming apparatus according to the invention will be described in detail with reference to the drawings.

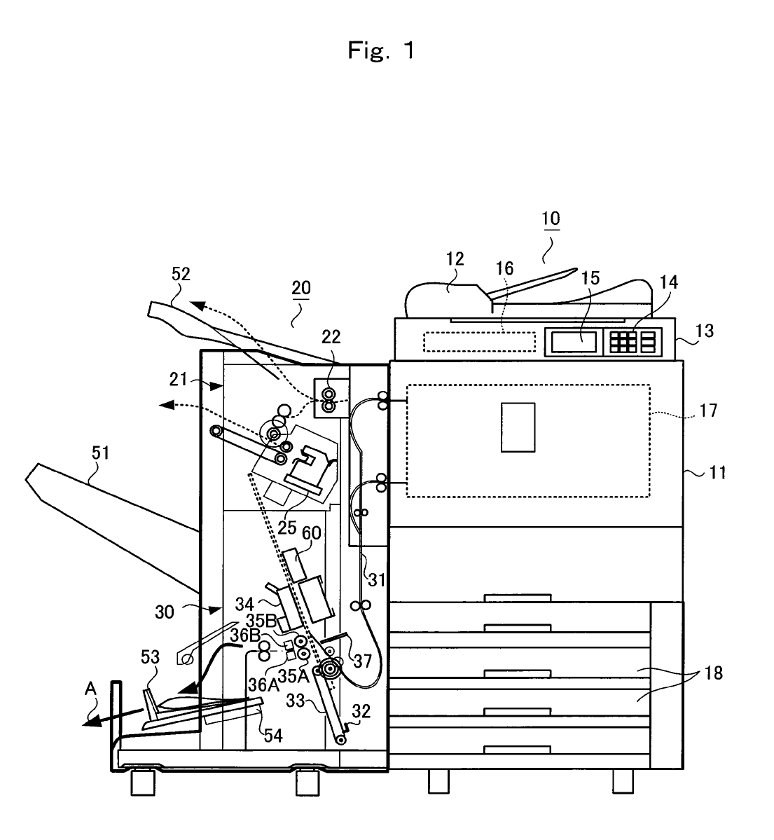

FIG. 1 is a side sectional view showing an image forming apparatus 10 according to this embodiment. As shown in FIG. 1, a finisher 20 is installed adjacently to the image forming apparatus 10 such as a copy machine, MFP (multifunction peripheral) or printer.

The image forming apparatus 10 has an automatic document feeder 12 which sends sheets of an original one by one, a scan unit 16 which scans the original, and sheet cassettes 18 which house recording media. The image forming apparatus 10 also has a body unit 11 housing an image forming unit 17 which forms an image on recording media carried one by one from the sheet cassettes 18, and a control unit 13 including a control panel 15 and operation buttons 14. The image forming apparatus 10 hands recording media with an image formed thereon to the finisher 20.

The finisher 20 has a staple mechanism 21 which performs stapling, and a first folding unit 30 which folds, recording media in the middle.

The staple mechanism 21 has a stapler 25 which staples recording media carried by a carrying roller 22.

If neither stapling nor middle folding is carried out, recording media are discharged to a paper discharge tray 52 on an upper stage. Stapled recording media are discharged to a movable paper discharge tray 51 on a middle stage.

The first folding unit 30 has a carrying mechanism 31 which carries recording media, a longitudinal alignment device 32 which temporarily has the carried recording media stacked thereon and longitudinally aligns the recording media, and a moving device 33 which carries the aligned recording media to a stapling position or a middle folding position.

The first folding unit 30 further includes a stapler 34 and a middle folding mechanism. The middle folding mechanism has a middle folding driving roller 35A and a middle folding driven roller 35B as a pair of middle folding rollers for folding the recording media in the middle, a middle folding blade 37 which pushes the recording media into a nip part between the middle folding driving roller 35A and the middle folding driven roller 35B, and a fold reinforcing unit 36 which reinforces the folding of the recording media that are folded in the middle.

The fold reinforcing unit 36 has a lower fold reinforcing roller 36A and an upper fold reinforcing roller 36B as a pair of fold reinforcing rollers.

The middle folding roller has a rotation axis in a direction perpendicular to the sheet carrying direction. The fold reinforcing rollers have a rotation axis parallel to the sheet carrying direction.

In the fold reinforcing unit 36, the lower fold reinforcing roller 36A and the upper fold reinforcing roller 36B nip the fold of the recording media that are folded in the middle, and move along the rotation axis of the middle folding roller, thus reinforcing the fold.

In the case of stapling the recording media, the recording media are first carried to the stapling position and stapled by the staple mechanism 21. Next, the stapled recording media are folded in the middle by the first folding unit 30.

The recording media that are folded in the middle are discharged to a stack tray 53. This stack tray 53 has a stack tray moving mechanism 59 below. The stack tray moving mechanism 54 moves the stack tray 53 by a predetermined length in the direction of arrow A, that is, in the direction to which the recording media are discharged, every time the recording media that are folded in the middle are discharged. Therefore, the recording media that are folded in the middle are stacked with a shift of a predetermined length on the stack tray 53.

The finisher 20 may have a vertical alignment device which discharges the recording media to be discharged to the stack tray 53 with a shift in a vertical direction, that is, in the direction to the depth or to the front as viewed from the operator, for each print job.

The finisher 20 has a second folding unit 60 downstream from the first folding unit 30 in the recording medium carrying direction. The second folding unit 60 folds and presses a corner of the carried recording media.

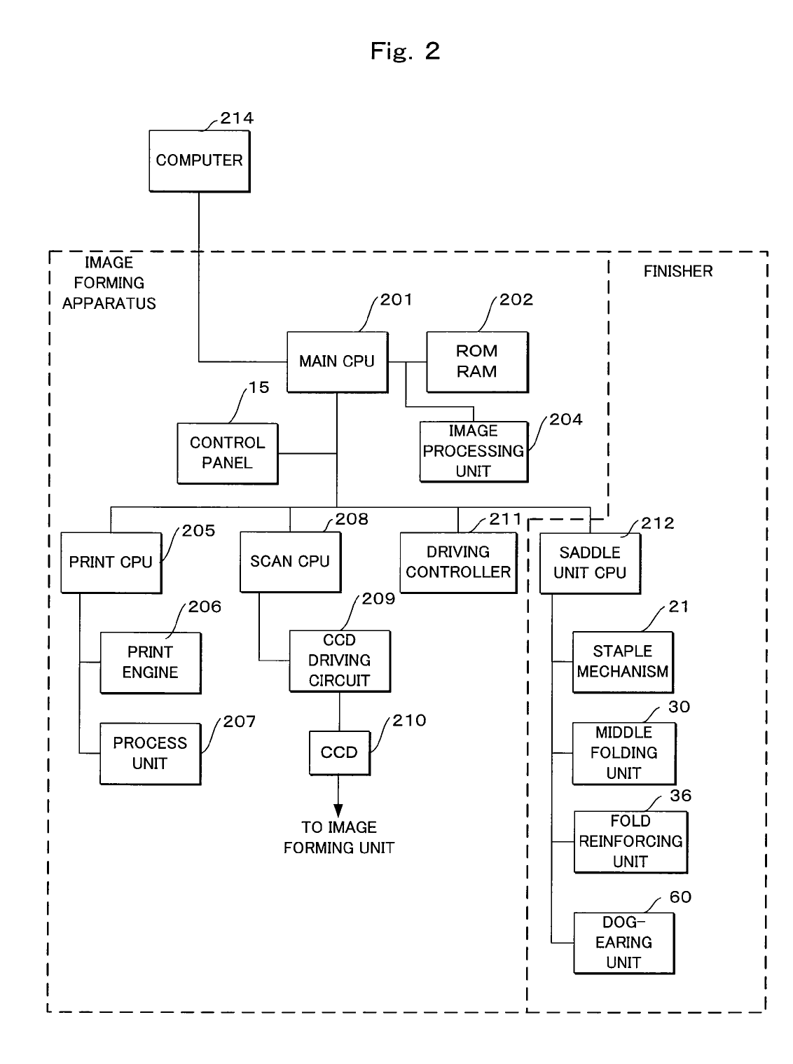

FIG. 2 is a block diagram showing a control system of the image forming apparatus 10 and the finisher 20. As shown in FIG. 2, the image forming apparatus 10 has a main CPU 201 as a control unit which controls the entire image forming apparatus 10, a control panel 15 connected to this main CPU 201, a memory 202 including a ROM or RAM as a storage device, an image processing unit 204 which carries out image processing, a print CPU 205 which controls printing, a scan CPU 208 which controls the scan unit 16, a driving controller 211 which controls the recording medium carrying roller, and a saddle unit CPU 212 as a control unit which controls the finisher 20.

The main CPU 201 is connected to a computer 214 such as a personal computer or server via an interface.

The print CPU 205 controls a print engine 206 which forms an image, and a process unit 207 which fixes the image formed on a recording medium.

The scan CPU 208 controls a CCD driving circuit 209 which drives a CCD (charge coupled device) 210.

The saddle unit CPU 212 controls the staple mechanism 21, the first folding unit 30, the fold reinforcing unit 36, and the second folding unit 60.

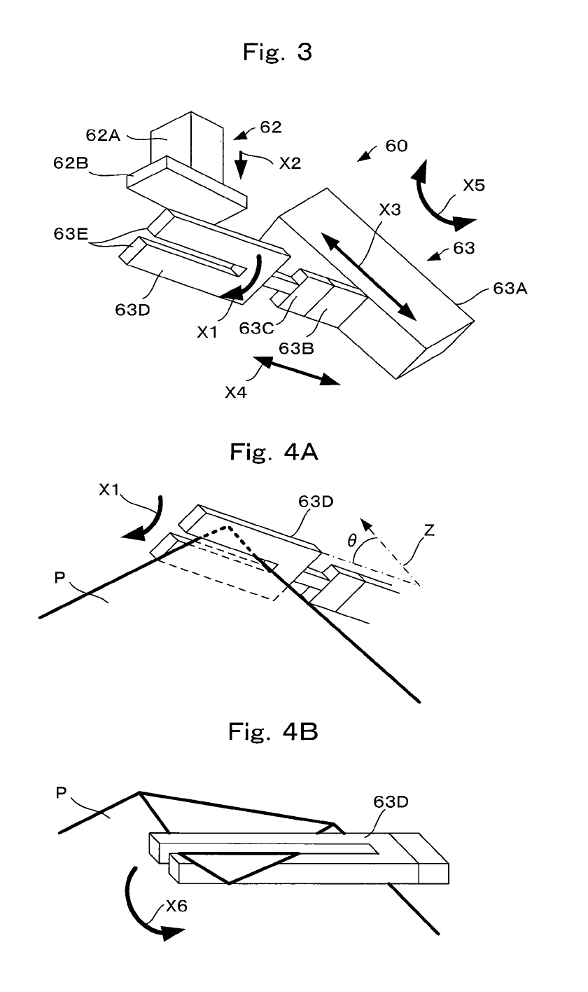

FIG. 3 is a perspective view showing the appearance of the second folding unit 60. As shown in FIG. 3, the second folding unit 60 has a dog-earing portion 63 and a dog-eared fold reinforcing portion 62.

The dog-earing portion 63 has a dog-earing arm 63D which nips and folds a corner of a recording medium, and an expansion-contraction mechanism 63C which supports dog-earing arm 63D and moves the dog-earing arm 63D in the direction of arrow X4, that is, in the direction parallel to the longitudinal direction of the dog-earing arm 63D.

The dog-earing arm 63D is U-shaped with an open distal end. A spacing large enough to nip a recording medium is provided between two arms 63E forming this U-shape.

The dog-earing portion 63 also has a rotation motor 63B as a rotation mechanism which rotates the dog-earing arm 63D in the direction of arrow X1, that is, about a rotation axis parallel to the longitudinal direction of the dog-earing arm 63D, and a dog-earing arm moving mechanism 63A which moves the dog-earing arm 63D in the direction of arrow X3, that is, in the direction parallel to the recording medium carrying direction.

The dog-earing arm moving mechanism 63A has a built-in turning motor and turns the dog-earing portion 63 in a reciprocating manner in the direction of arrow X5, that is, in such a manner that the dog-earing arm 63D arcs.

The dog-earing arm moving mechanism 63A and the expansion-contraction mechanism 63C may be driven by a gear or may be driven by a timing belt.

The dog-eared fold reinforcing portion 62 has a pressing portion 62B which presses, with a plate-like flat surface, the corner of the recording medium folded by the dog-earing arm 63D and thus reinforces the fold, and a pressing portion lifting-lowering mechanism 62A which lifts and lowers the pressing portion 62B in the direction of arrow X2, that is, in the direction of the dog-earing arm 63D.

The pressing portion lifting-lowering mechanism 62A can be driven, for example, by using a solenoid.

FIG. 4A shows the operation of the dog-earing arm 63D. As shown in FIG. 4A, when the image forming apparatus 10 sends the size of a designated recording medium to the saddle unit CPU 212 from the main CPU 201, the finisher 20 drives the dog-earing arm moving mechanism 63A and the expansion-contraction mechanism 63C to move the dog-earing arm 63D so that the dog-earing arm 63D comes to the position to nip a corner of the recording medium.

The dog-earing arm 63D is installed with an inclination toward the recording medium so that its angle θ to the sheet carrying direction Z is 45 degrees or smaller. The dog-earing arm 63D stands by in an attitude perpendicular to the surface of the recording medium, as shown in FIG. 4A.

As a recording medium P is carried in, a corner of the recording medium enters the spacing between the arms 63E. In the state where the carrying of the recording medium is stopped, the rotation motor 63B rotates and thus rotates the dog-earing arm 63D by 90 degrees in the direction of arrow X1.

The dog-earing arm 630 rotates by 90 degrees and then stops. Here, the pressing portion lifting-lowering mechanism 62A pushes down the pressing portion 62B. The pressing portion 62B nips the corner of the recording medium together with the dog-earing arm 63D and thus forms a fold.

FIG. 4B shows the sequel to the operation of the dog-earing arm 63D. As shown in FIG. 4B, the dog-earing arm 63D is further turned in the direction of arrow X6, that is, upstream in the sheet carrying direction by the turning motor, for example, by 20 degrees.

After that, the expansion-contraction mechanism 63C causes the dog-earing arm 63D to retreat. At this time, the pressing portion 62B remains lowered and the fold on the recording medium is stroked between the dog-earing arm 63D and the pressing portion 62B. As the dog-earing arm 63D retreats, the first folding unit 30 folds the recording medium in the middle.

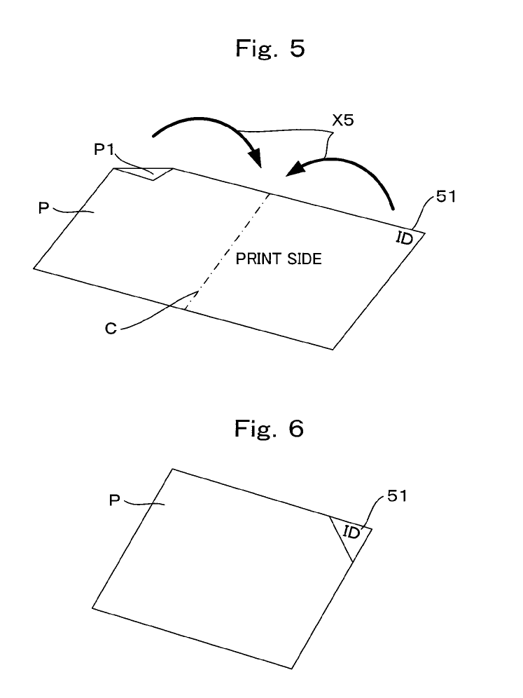

FIG. 5 shows the state of the recording medium before middle folding. As shown in FIG. 5, an image of an ID 51 is formed at a position corresponding to the folded corner of the recording medium, on a print side of the recording medium P, using a straight line C to be the fold of the middle folding as a symmetry axis, that is, at a position where the ID 51 can be visually recognized when the recording medium is folded in the middle.

The ID 51 may be a user ID or print user name as long as the ID 51 can specify the print user. The ID 51 may also be a department name, department code, date, time or the like. The ID 51 may be set through the control panel 15 or may be set from the computer 214. The first folding unit 30 folds the recording medium in the middle as indicated by arrows X5.

FIG. 6 shows the state of the recording medium that is folded in the middle and discharged to the stack tray 53. As shown in FIG. 6, since the corner P1 shown in FIG. 5 is folded, the ID 51 printed on the print side of the recording medium can be visually recognized.

As described above, the image forming apparatus 10 according to this embodiment has the dog-earing arm 63D which folds a corner of a recording medium, and the dog-eared fold reinforcing portion 62 which presses the corner of the recording medium folded by the dog-earing arm 63D and thus reinforces the fold. The ID 51 is printed at a position that can be visually recognized when the recording medium is folded in the middle, and the recording medium is then folded in the middle. Therefore, the print user can be specified without viewing the inside of the printed matter that is folded in the middle. There is an advantage that security can be secured simply without raising the print cost.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
an image forming unit which forms an image on a recording medium;
a first folding unit which folds the recording medium having the image formed thereon, in the middle;
a second folding unit which folds a corner of the recording medium that is carried downstream from the first folding unit in a recording medium carrying direction; and
a control unit which forms an image of ID at a position corresponding to the folded corner of the recording medium, using a straight line to be a fold of middle folding on a print side of the recording medium, as a symmetry axis.

2. The apparatus according to claim 1, wherein the second folding unit has a dog-earing arm having a U-shape with an open distal end and provided with a spacing large enough to nip the recording medium between two arms forming the U-shape.

3. The apparatus according to claim 2, wherein the second folding unit has a rotation mechanism which rotates the dog-earing arm about a rotation axis parallel to a longitudinal direction of the dog-earing arm.

4. The apparatus according to claim 3, wherein the second folding unit has a dog-earing arm moving mechanism which moves the dog-earing arm in a direction parallel to the recording medium carrying direction.

5. The apparatus according to claim 4, wherein the second folding unit has a dog-eared fold reinforcing portion which presses the corner of the recording medium folded by the dog-earing arm and thus reinforces the fold.

6. The apparatus according to claim 5, wherein the dog-eared fold reinforcing portion has:
a pressing portion which presses, with a plate-like flat surface, the corner of the recording medium folded by the dog-earing arm and thus reinforces the fold; and
a pressing portion lifting-lowering mechanism which lifts and lowers the pressing portion in a direction of the dog-earing arm.

7. The apparatus according to claim 6, wherein the control unit drives the dog-earing arm moving mechanism and an expansion-contraction mechanism in accordance with a size of a designated recording medium and moves the dog-earing arm so that the dog-earing arm comes to a position to nip a corner of the recording medium.

8. The apparatus according to claim 7, wherein in the second folding unit, the expansion-contraction mechanism causes the dog-earing arm to retreat before the first folding unit folds the recording medium in the middle after the dog-eared fold reinforcing portion reinforces the fold.

9. The apparatus according to claim 8, wherein in the second folding unit, the expansion-contraction mechanism causes the dog-earing arm to retreat, with the pressing portion remaining pressed down.

10. The apparatus according to claim 9, wherein the dog-earing arm is installed with an inclination toward the recording medium at an angle of 45 degrees or smaller to a sheet carrying direction.

11. An image forming method for an image forming apparatus comprising:
an image forming unit forming an image on a recording medium;
a control unit forming an image of ID at a position corresponding to a folded corner of the recording medium, using a straight line to be a fold of middle folding on a print side of the recording medium, as a symmetry axis;
a second folding unit folding a corner of the recording medium that is carried, the second folding unit being arranged downstream from a first folding unit in a recording medium carrying direction; and
the first folding unit folding the recording medium having the image formed thereon in the middle.

12. The method according to claim 11, wherein the second folding unit has a dog-earing arm having a U-shape with an open distal end and provided with a spacing large enough to nip the recording medium between two arms forming the U-shape to nip a corner of the recording medium.

13. The method according to claim 12, wherein a rotation mechanism rotates the dog-earing arm about a rotation axis parallel to a longitudinal direction of the dog-earing arm.

14. The method according to claim 13, wherein a dog-earing arm moving mechanism moves the dog-earing arm in a direction parallel to the recording medium carrying direction.

15. The method according to claim 14, wherein a dog-eared fold reinforcing portion presses the corner of the recording medium folded by the dog-earing arm and thus reinforces the fold.

16. The method according to claim 15, wherein a pressing portion presses, with a plate-like flat surface, the corner of the recording medium folded by the dog-earing arm and thus reinforces the fold, and
a pressing portion lifting-lowering mechanism lifts and lowers the pressing portion in a direction of the dog-earing arm.

17. The method according to claim 16, wherein the control unit drives the dog-earing arm moving mechanism and an expansion-contraction mechanism in accordance with a size of a designated recording medium and moves the dog-earing arm so that the dog-earing arm comes to a position to nip a corner of the recording medium.

18. The method according to claim 17, wherein in the second folding unit, the expansion-contraction mechanism causes the dog-earing arm to retreat before the first folding unit folds the recording medium in the middle after the dog-eared fold reinforcing portion reinforces the fold.

19. The method according to claim 18, wherein in the second folding unit, the expansion-contraction mechanism causes the dog-earing arm to retreat, with the pressing portion remaining pressed down.

20. The method according to claim 19, wherein a corner of the recording medium is folded by the dog-earing arm installed with an inclination toward the recording medium at an angle of 45 degrees or smaller to a sheet carrying direction.
